(19) United States
(12) Patent Application Publication
(10) Pub. No.: US 2007/0233438 A1
(43) Pub. Date: Oct. 4, 2007

(54) Method and system for simulation-based troubleshooting and fault verification in operator-controlled complex systems

(75) Inventors: Remi Quimper, Montreal (CA); Kamilia Sofia, Dollard-des-Ormeaux (CA); Gilbert Deziel, Verdun (CA); Nohad Zariffa, Dollard-des-Ormeaux (CA)

Correspondence Address: OGILVY RENAULT LLP, 1981 MCGILL COLLEGE AVENUE, SUITE 1600, MONTREAL, QC, H3A2Y3, CA

(73) Assignee: CAE INC., Saint Laurent (CA)

(21) Appl. No.: 11/227,287

(22) Filed: Sep. 16, 2005

Related U.S. Application Data
(63) Continuation of application No. 10/880,495, filed on Jul. 1, 2004, now abandoned.

(51) Int. Cl. G06G 7/48

(52) U.S. Cl. 703/6

(57) ABSTRACT

Troubleshooting a cause of anomalous behavior observed during operation of a complex system is enabled by a simulation system that permits an operator to operate a simulation of the complex system to initial control conditions in which the anomalous behavior was observed, and suspend the simulation to input fault symptoms observed during the anomalous behavior. The system selects fault scenarios using the input fault symptoms, injects a selected fault scenario into the simulation, and compares a behavior of the fault-inserted simulation to a behavior of a fault-free simulation operating under the initial control conditions to extract fault symptoms, in order to determine whether the anomalous behavior is reproduced by any inserted fault scenario.

### CROSS-REFERENCE TO RELATED APPLICATIONS

This application is a continuation of U.S. patent application Ser. No. 10/880,495 filed Jul. 1, 2004.

### MICROFICHE APPENDIX

Not Applicable.

### TECHNICAL FIELD

The present invention relates in general to troubleshooting and maintenance of complex systems, and in particular to a method and apparatus for using a simulation of an operator-controlled complex system to identify and verify a fault hypotheses in response to anomalous behavior observed during operation of the complex system.

### BACKGROUND OF THE INVENTION

Operator-controlled complex systems, such as commercial, military, and aerospace vessels, nuclear reactors, and many other expensive and/or potentially dangerous systems include vast arrays of components and subsystems that work together in complex ways. Trained maintenance personnel must monitor, repair and maintain the various components and subsystems in order to keep such complex systems in safe working order. The understanding of, and ability to predict the behaviors of, the components and subsystems in response to changing internal and external environmental conditions, actions by an operator, and other events, is crucial to maintenance of such complex systems.

Given the variability of behaviors of some complex systems, it is not possible to provide maintenance personnel with a complete rational understanding of the system in every possible scenario. However maintenance training is frequently provided in known ways using simulations. Simulations of complex systems have long been used for training people to operate, maintain, and perform related procedures on complex systems. High fidelity and full-scope simulations are known to be particularly important for providing a realistic replication of complex system control equipment, and a realistic environment in which the training can take place.

Complex systems training has been developed to incorporate failure states and/or error conditions so that during operation of a virtual complex system, either a courseware program, or an instructor can introduce one of a predefined set of faults into the virtual system, so that the trainee can learn how to identify, and respond in a similar situation. While this is very useful, it is of limited value for the purposes of troubleshooting. Despite elaborate testing of complex systems, and extensive operator training, complex systems may still behave in ways that are unexpected by operators. This may be due to limited training facilities, or limits on understanding of how the complex system responds to certain environmental conditions, operator actions, equipment failures or malfunctions etc.

In accordance with the prior art, it is known for vendors and operators of complex systems and/or their control interfaces (usually original equipment manufacturers OEMs) to provide a diagnostic database of potential faults and/or failures. The diagnostic database permits a correlation of symptoms exhibited by the complex system with one or more possible faults, and in some cases a limited specification of environment and operating conditions of the complex system. While these diagnostic databases are widely used, they are very expensive to compile and maintain. This is because such databases are generally populated by subject matter experts who may, in some cases, be assisted by expert or artificial intelligence (AI) systems.

In spite of efforts to date there is generally a very low level of integration of the fault and failure scenarios with operating conditions and environmental factors, operator control actions, etc. The low level of integration with the operating conditions and operator control actions introduces limits on the usefulness of the diagnostic databases. However, the expense of providing a higher level of integration and more context-based failure-symptom associations using prior art methods would drive up the investment required to compile such a diagnostic database to unacceptable levels.

U.S. Pat. No. 5,161,158, which issued to Boeing on Nov. 3, 1992, teaches a failure analysis system for “simulating” the effect of a subsystem failure on an electronics system. The failure analysis system includes a knowledge base; a user interface, and a failure analysis engine. The user interface permits a system analyst to enter simulation condition data to the failure analysis engine, which runs a “simulation” of the electronics system using electronics specification data in the knowledge base. More precisely the simulation is an artificial intelligence (AI) for tracing a fault path through a plurality of interconnected “line replaceable units”. The simulation condition data may be manually input or may be taken from a medium that stores in-flight data that describes the actual flight operating configuration during which a flight deck effect (symptom) occurred. The kind and number of simulation state conditions, the manner in which they are entered, and the nature of the simulation, suggest a model that does not account for complex interactions between environmental factors and the complex system being modeled; the information is input in a manner that is not conducive to expressing in detail the operating condition of the avionics equipment when the “flight deck effect” was observed; and the output is not presented in a manner that permits a complete evaluation of the conclusion, or in a way that facilitates learning by maintenance personnel.

It is well understood in the art that most commercial and military vessels, as well as other complex systems are operated within tighter margins than has been the case in the past. Tight scheduling, just-in-time delivery and provisioning, and thin backup margins require maintenance decisions to be quickly and effectively made. In many instances, it is desirable to make maintenance decisions before maintenance personnel can physically inspect a complex system in need of maintenance. For example, if an in-transit fault occurs in a commercial aircraft, it would be of great value to determine whether the flight can safely continue to a predetermined destination, or must be interrupted, whether a replacement aircraft is required or a repair can be made in a predetermined turn-around time, etc. Such decisions cannot be reliably made using prior art methods of troubleshooting and fault verification.

Accordingly, there remains a need for a method and apparatus for simulation-based troubleshooting and fault verification in an operator-controlled complex system.

### SUMMARY OF THE INVENTION

It is therefore an object of the invention to provide a method and apparatus for simulation-based troubleshooting and fault verification in an operator-controlled complex system.

It is another object of the invention to provide a method and apparatus for permitting maintenance personnel to input information about anomalous behavior of complex systems using a virtual complex system control station.

It is further an object of the invention to provide a method and apparatus that verifies fault hypotheses by automatically comparing output of a fault-inserted simulation with a fault-free simulation to isolate symptoms caused by the fault, and to compare the symptoms with symptoms input by the operator.

The fault isolation system in accordance with the invention includes at least a simulation of the complex system, a fault resolver, symptoms comparator and extractor, and a virtual complex system (VCS) control station that operates in two modes. In a simulation mode, an operator uses the VCS control station to operate the simulation; and in a symptom specification mode, the operation of the simulation is suspended and the operator uses a graphical user interface to input fault symptoms associated with an anomalous behavior manifest during operation of the complex system. The fault symptoms are sent to a fault resolver that identifies candidate fault scenarios using both the fault symptoms and control information from the VCS.

The fault resolver automatically inserts candidate fault scenarios into the simulation, so that a symptoms exhibited by the fault-inserted simulation can be used to determine a likelihood that a fault scenario is the cause of the anomalous behavior.

The VCS control station preferably provides an operator interface that permits the operator to: effect a change from the simulation mode to the fault symptom input mode; input of at least one fault symptom that is sent to the fault resolver.

In order to permit automatic fault scenario verification, the troubleshooting system operates a fault-free copy of the simulation of the complex system, which is run in parallel with the fault-inserted copy of the simulation. A symptom extractor compares an operating state of the fault-free copy of the simulation with the fault-inserted copy of the simulation, and extracts fault symptoms from the fault-inserted copy of the simulation. A symptom comparator compares the extracted fault symptoms with the fault symptoms input by the operator to compile a ranked list of probable fault scenarios.

The operator interface is preferably further adapted to display the ranked list of fault scenarios at the operator control interface to permit the operator to select one of the fault scenarios, and to enter a free play mode in which the fault scenario is inserted.

### BRIEF DESCRIPTION OF THE DRAWINGS

Further features and advantages of the present invention will become apparent from the following detailed description, taken in combination with the appended drawings, in which:

FIG. 1 is a schematic diagram illustrating principal components of the simulation-based troubleshooting and fault validation system in accordance with the invention;

FIG. 2 is a diagram illustrating the VCS control station “simulation mode” and “fault symptom input mode”; and

FIG. 3 is a flow chart illustrating principal steps involved in a process for isolating and validating a fault scenario in accordance with the system shown in FIG. 1.

It should be noted that throughout the appended drawings, like features are identified by like reference numerals.

### DETAILED DESCRIPTION OF THE PREFERRED EMBODIMENT

The present invention provides a method and apparatus for troubleshooting anomalous behavior of a complex system. Specifically the invention is directed to a system and a method that uses a specially adapted simulation of the complex system for determining which of a number of potential faults is a cause of some anomalous behavior observed while operating the complex system. The method and apparatus significantly facilitates fault isolation required for troubleshooting the complex system. In accordance with an embodiment of the invention, determining a cause of the anomalous behavior involves a simple, largely automated process. An operator, normally a maintenance person, performs a first step of operating the simulated complex system to achieve an operating state similar to the state of the complex system when the anomalous behavior was observed. The operator then uses a special user interface associated with an operator control station of the simulated complex system to input fault symptoms observed during the anomalous behavior. The input fault symptoms are passed to a fault resolver application, which selects candidate fault scenarios and generates a list of the candidate fault scenarios using the fault symptoms input by the operator and the operating state of the complex system obtained by operating a virtual complex system to simulate conditions in which the anomalous behavior was observed. Each fault scenario in the candidate fault scenario list is validated and ranked, and the ranked list of candidate fault scenarios is passed back to the operator via the special user interface. The operator can then test the probable fault scenarios by launching a fault-inserted simulation in a free play mode to verify that the anomalous behavior is replicated.

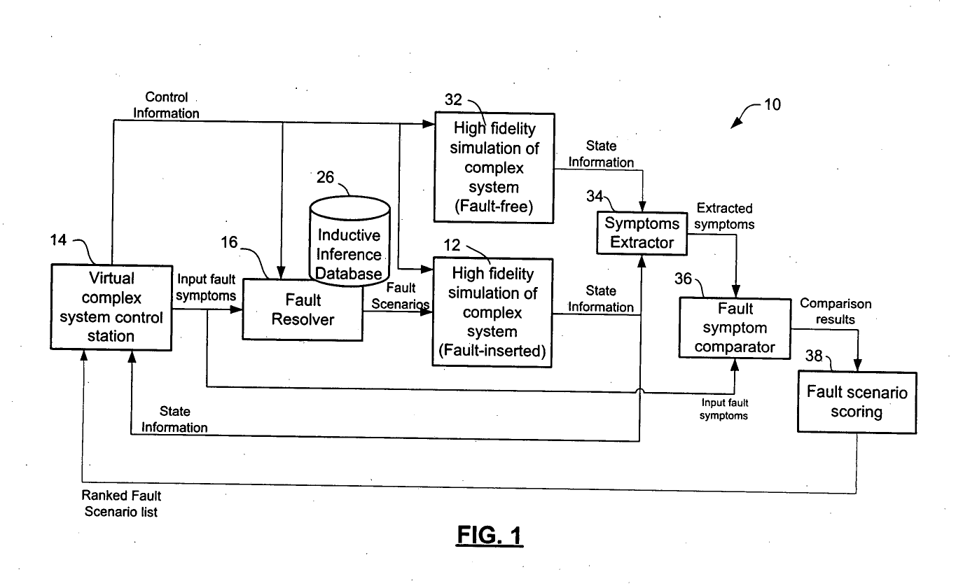

FIG. 1 is a schematic diagram of principal functional components of a simulation-based troubleshooting system 10 in accordance with an embodiment of the invention, hereinafter referred to simply as the troubleshooting system 10.

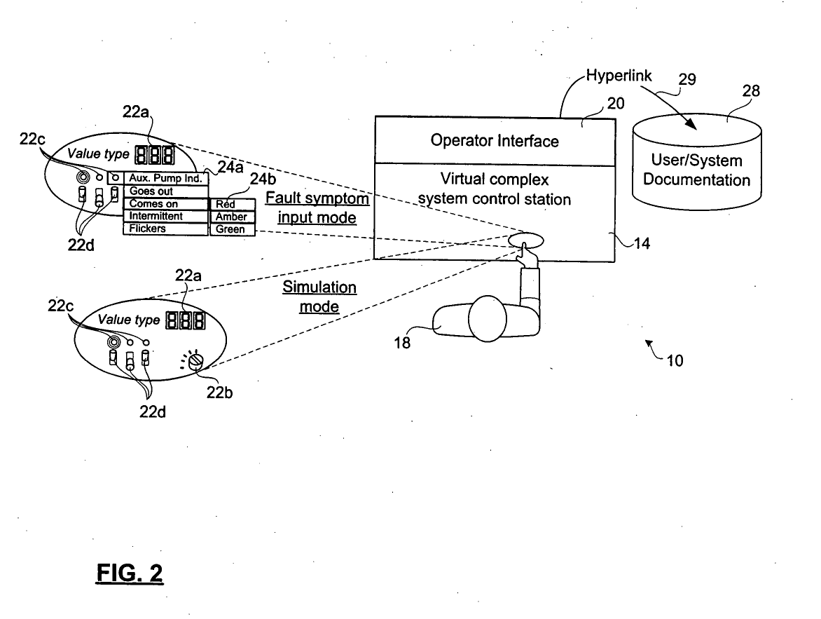

The virtual complex system (VCS) operator control station 14 provides an operator control station that is similar to, and preferably substantially identical to, a control station of the complex system for which troubleshooting is required. For example, the VCS control station 14 may simulate an aircraft cockpit, a military vehicle operator station, a naval vessel pilot station, a power plant control station, a heavy equipment operator station, or any other complex system control station. The VCS control station 14 is in communication with the simulation 12 so that as changes to simulation parameters are made by the simulation 12, corresponding changes to interface components (which include displayed dials, gauges, analog and/or digital meters, actuators, control panels; images of simulated environments shown through virtual windows, or display screens, aural cues, etc.) are presented to an operator 18 (FIG. 2), typically a maintenance person, in a manner well known in the art.

FIG. 2 shows a small region of the VCS control station 14 enlarged in the “simulation mode” featuring a plurality of interface elements 22; nominally: digital meter 22a; selector dial 22b, and three LEDs 22c, each of which LEDs 22c is associated with a respective toggle switch 22d. It will be noted that the interface elements 22 are in a state that indicates a condition of the VCS, so that the digital meter 22a displays a value (206), a first of the LEDs 22c is “on”, the dial 22b shows a setting, and a first and third of the toggle switches 22d are “up” while a second one is “down”. The VCS control station 14 further permits the operator 18 to interact with the VCS by actuating controls, etc, in a manner generally identical to the way in which the real system is operated. In accordance with the illustrated embodiments, the VCS control station 14 may include a plurality of touch screen interfaces as taught in co-pending, co-assigned U.S. patent application Ser. No. 10/139,816, filed on May 7, 2002 entitled 3-DIMENSIONAL APPARATUS FOR SELF-PACED INTEGRATED PROCEDURE TRAINING AND METHOD OF USING SAME, which is incorporated herein by reference.

In accordance with the embodiment illustrated FIG. 1, the VCS control station 14 provides a special graphical user interface (GUI) 20 (or any other suitable control interface) that permits the operator 18 to suspend the simulation 12, and input fault symptoms to a fault resolver 16 (FIG. 1). Preferably, the GUI 20 (FIG. 2) permits the operator to effect a change at any time from the simulation mode to a fault symptom input mode to input the fault symptoms. The GUI also permits the operator 18 to select a fault scenario from a candidate fault scenario list to resume the simulation in a fault inserted free play mode, as will be explained in more detail below.

It will be appreciated by those skilled in the art that the information exchanged between the fault resolver 16 and the GUI 20 may be effected via the simulation 12, and that the simulation 12, fault resolver 16 and VCS control station 14 may be embodied as any number of databases, servers, computers, and other computing and interface equipment subject to processing requirements, and that this computing and interface equipment may all be local to the VCS control station 14, or some of it may be connected via a network, in a manner well known in the art.

The simulation 12 is preferably a full-scope, high-fidelity simulation of the complex system. A full-scope, high-fidelity simulation is a simulation that realistically simulates the behavior of the real complex system at the VCS control station 14 under substantially any operating condition, including realistic simulation of behaviors when a mechanical or control system fault occurs. The simulation 12 is programmed to enter a suspended state in response to a command input by the operator, and to place the GUI 20 into the fault symptom input mode in which the GUI 20 permits the operator to input fault symptoms. On entering the suspended state, all simulation variables are preserved to permit the simulation 12 to be resumed as if the suspended state had never been entered.

Preferably, when the simulation 12 is suspended and the GUI 20 of the operator's control station 14 is in the fault symptom input mode, each of the interface elements 22 provide a situated representation space through which the operator inputs the fault symptoms. This situated representation space improves the operator's ability to recreate the fault symptoms exhibited by the complex system when the anomalous behavior of the complex system was observed, making the troubleshooting system 10 more accurate and complete. This is facilitated in embodiments where the VCS control station 14 includes touch sensitive display screen technologies over which symptom selection menus etc. can be displayed. In other embodiments the interface element 22 in conjunction with the control GUI 20 may be used to specify a condition of the interface element 22 during the anomalous behavior. While the selection of an interface element 22 when the simulation is in an operating mode triggers associated control input to the VCS (e.g. rotating a dial, toggling a switch, etc.), activating the same interface element 22 during the fault symptom input mode results in either the input of a unique fault symptom, or in the presentation of a selection menu that permits the operator 18 to select one of a plurality of condition change fault symptoms associated with the interface element 22.

The illustrated example in FIG. 2 of a small region of the VCS control station 14, in accordance with the fault symptom input mode, shows that a third one of the LEDs 22c has been selected by the operator 18, and the operator 18 has been presented with a menu 24a of options associated with the selected LED 22c (an auxiliary pump lamp). The menu includes options for specifying the fault symptom observed at LED 22c. The exemplary options include “goes out”, “comes on”, “flashes intermittently”, or “flickers”. Having selected the “comes on” option, a color submenu 24b with options red, amber and green is displayed. In this hypothetical example, the option indicates that the LED 22c “comes on” and is amber. It should be understood that there are many alternative, effective ways that the fault symptom(s) can be input using control GUI 20 of the VCS control station 14, aside from using pull-down menus or the like. One alternative is to toggle between the possible conditions of the user input (by clicking on the control or indicator).

It should be noted that some of the symptomatic behaviors of a complex system may not be amenable to description in this manner. For example, a part of the complex system may begin to smoke; an explosion, an implosion, or sparking may be observed; an audible sound that indicates a broken fixture, or a leak of a pressurized fluid may be heard, etc. Visual fault symptoms may be input using a pane that provides various views of the VCS. Aural fault symptoms may be input using menu selections or even a microphone, or the like.

Once the fault symptoms have been input, the fault symptom data is forwarded to the fault resolver 16 (FIG. 1). In accordance with one embodiment of the invention, symptoms, VCS control information and simulation status are translated into a query by the fault resolver 16 in order to search an inductive inference database 26.

Inductive inference database 26 contains multiple fault symptom/fault scenario inference pairs previously computed by inserting all known fault scenarios in a simulation model and extracting all resulting symptoms. The simulation model used to populate the inductive inference database 26 is an exact duplicate of simulation 12 operating under the same, or similar, conditions.

Each of the fault symptom/fault scenario pairs may be associated by one or more logical relations to operating states of the VCS. Accordingly, the fault resolver 16 may compare operating states of the VCS with conditions of the logical relations to determine if, or to what extent, the fault symptoms and the fault scenario are related. If it is not clear whether the fault symptoms and the fault scenario are related, the fault resolver 16 may query the simulation 12 to access state information regarding the condition of any modeled environment, or the operating state of the VCS, and may also query the operator 18 via the GUI 20 to request input of any other observed fault symptoms, for example.

The fault resolver 16 uses the input fault symptoms and the state information to query the inductive inference database 26 in order to compile the fault scenario list. The fault resolver 16 then sequentially inserts each candidate fault scenario into the fault-inserted simulation 12. Furthermore, state information from the fault-inserted simulation 12 may or may not be output to the VCS control station 14 during the evaluation of the respective candidate fault scenarios. However, the operator 18 may be able to verify the most likely candidate fault scenarios using a free play mode of the simulation 12, at which point state information from the simulation 12 is output to the VCS control station 14.

The purpose of the fault-free simulation 32 (FIG. 1) is to permit the detection of symptoms that are related to the inserted fault scenario. This comparison is made by simultaneously streaming simulation data from the fault-inserted simulation 12 and the fault-free simulation 32 to a symptom extractor 34. The symptom extractor 34 uses differences in the two data streams as well as algorithms for determining whether any difference is significant in order to identify symptoms that are caused by the fault scenario. The extracted symptoms are forwarded to a fault symptom comparator 36, which compares the extracted symptoms with symptoms that were input by the operator 18, in order to generate a list of symptom comparisons to a fault scoring process 38. The fault scoring process 38 uses the symptom comparisons in conjunction with a set of rules for ranking the relevance of each extracted symptom, to produce a ranking of the candidate fault scenarios. If the likelihood that extracted fault symptoms match the operator input fault symptoms is below a predetermined threshold, the candidate fault scenario is not included in the ranked fault scenarios list.

The ranked fault scenario list is presented to the operator 18 (via the GUI 20) to permit the operator 18 to select one of the candidate fault scenarios, and to continue the simulation in a free play mode, permitting the operator 18 to interact with the fault-injected simulation. The ranked fault scenario list referenced in FIG. 1, may include one or more hyperlinks 29 (FIG. 2) associated with each fault scenario in the list. The ranked fault scenario list also includes an indication of a relative ranking of each fault scenario in the list. The operator 18 can use the hyperlink(s) to access user and/or maintenance documentation stored online in one or more user/maintenance documentation databases 28, or any other valuable or useful source of information that may assist the operator in understanding the fault scenario, making repairs, and/or changing procedures to correct or avoid the fault scenario in the future. The hyperlink information associated with the fault scenarios in the “ranked fault scenario list” by the fault resolver 16 is, in one embodiment, stored in the inductive inference database 26.

It should be noted that while the troubleshooting system 10 has been shown using fault-free and a fault-inserted simulations running in parallel, running more than two simulations in parallel permits the evaluation of more than one candidate fault scenario concurrently, which can be advantageous in some situations. Conversely, if simulation processing is limited but data storage is abundant, the process can be serialized by running the fault-free simulation 32 first (for a predefined period of time) and saving both the output of the fault-free simulation 32 and any corresponding environmental data (or other non-reproducible modeled data), and then running each fault-inserted simulation to supply the non-reproducible data. The output of the fault-inserted simulation 12 is then compared with the output of the fault-free simulation 32 that is retrievable by the symptom extractor 34, to achieve the control/test comparison in another way.

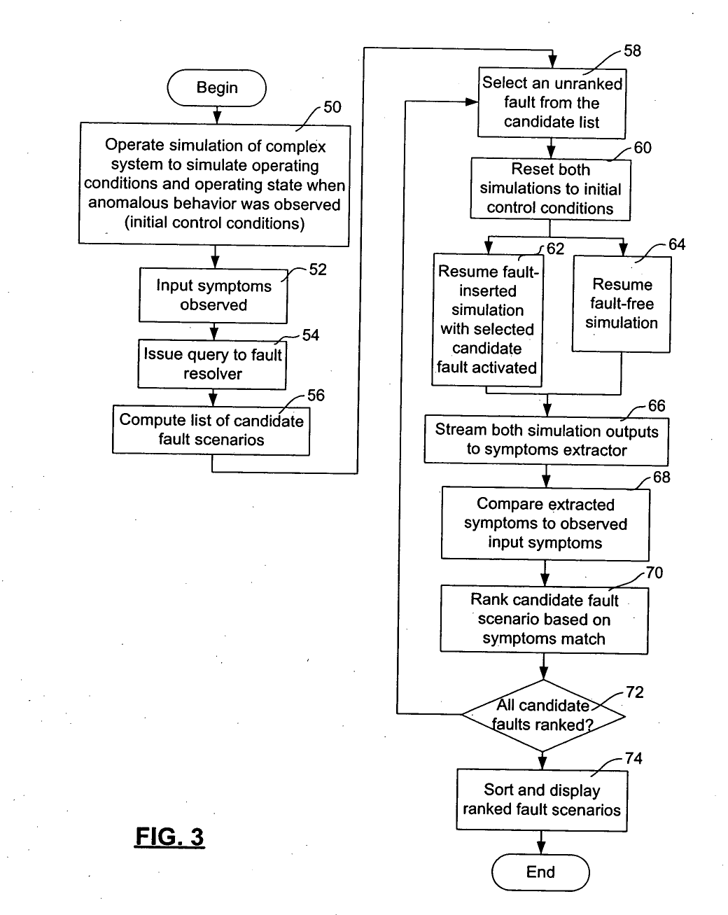

Principal steps involved in a process for troubleshooting using the troubleshooting system 10 are shown in FIG. 3.

The process begins when an operator operates the simulation 12 to simulate operating conditions and an operating state of the real complex system when the anomalous behavior was observed (step 50). Those conditions are identified as “initial control condition”. In step 52, after suspending the simulation and putting the GUI of the VCS control station 14 in “symptoms input mode”, the operator inputs the various symptoms that were observed, or reported. The input of the fault symptoms to the fault resolver 16 can then commence. The input fault symptoms are passed to the fault resolver 16 by, for example, issuing a query to the fault resolver 16. This is preferably automatically effected once the operator 18 has input all of the fault symptoms and exits the fault symptom input mode or indicates that fault symptom input is completed.

The query issued to the fault resolver 16 (step 54) contains the input fault symptoms, as well as the initial control conditions captured when the simulation was suspended, as explained above. On receipt of the query, the fault resolver 16 uses the fault symptoms and the initial control conditions to retrieve one or more probable fault scenarios from the inductive inference database 26, and compiles a fault scenario list (step 56). If the fault resolver 16 is unable to select any fault scenarios from the database, the fault resolver 16 may query the operator for additional observed fault symptoms.

After a fault scenario is selected (step 58) from the fault scenario list, the fault resolver 16 resets both simulations 12,32 (FIG. 1) using the preserved initial control conditions simulation variables and resumes execution of the fault-inserted simulation 12 (step 62). The fault-free simulation 32 is simultaneously resumed without an inserted fault scenario (step 64). The two simulations are operated at the same rate in response to the same modeled environments, etc. so that any difference between the outputs of the two simulations received by the symptom extractor 34 (FIG. 1) are a direct result of the inserted fault scenario (step 66).

If a sufficient number of symptoms have been extracted, the extracted symptoms (if any) are compared by the fault symptom comparator 36 (FIG. 1) with the operator input fault symptoms (step 68) and the candidate fault scenario is evaluated. Accordingly, the fault scenario scoring 38 uses the output of the fault symptom comparator 36 to compute a likelihood that the candidate fault scenario caused the anomalous behavior. Comparative value are used to rank the candidate fault scenario in relation to the other candidate fault scenarios in the list (step 70). It is then determined (in step 72) whether another candidate fault scenario remains to be analyzed. If so, the process returns to step 58. Otherwise, the fault scenario list is output to the GUI 20 of the VCS operator station 14 and/or to any other system adapted to use the list.

Although the invention has been described above with reference to a specific embodiment of the invention, it should be understood that many other systems may be used to implement the invention without departing from the scope or spirit of the claims.

The invention has therefore been described in relation to an apparatus and method for complex system troubleshooting using a simulation of the complex system. The embodiments of the invention are, however, intended to be exemplary only. The scope of the invention is therefore intended to be limited solely by the scope of the appended claims.

I/We claim:

1. A method of troubleshooting to determine a cause of anomalous behavior observed during operation of a complex system, comprising:
providing an operator's station that permits an operator to operate a simulation of the complex system to initial control conditions of the complex system that existed when the anomalous behavior was observed, and to input fault symptoms associated with the anomalous behavior;
using the fault symptoms to compile candidate fault scenarios known to be associated with the operation of the complex system; and
inserting at least one of the candidate fault scenarios into the simulation operating under the initial control conditions to determine whether the fault symptoms are reproduced.

2. The method as claimed in claim 1 wherein using the fault symptoms input by the operator further comprises using the initial control conditions in conjunction with the input fault symptoms to select fault scenarios that are inserted into the simulation.

3. The method as claimed in claim 2 further comprising:
providing an operator graphical user interface associated with the operator's station, the operator graphical user interface permitting the operator to input the fault symptoms.

4. The method as claimed in claim 3 further comprising displaying the candidate fault scenarios using the graphical user interface subsequent to the step of determining whether the fault symptoms are reproduced.

5. The method as claimed in claim 3 further comprising providing a fault resolver which receives the input fault symptoms and initial control conditions, and uses them to compile a list of fault scenarios from a database of fault scenarios.

6. The method as claimed in claim 5 further comprising:
running a fault-free simulation under the initial operating conditions of the complex system that existed when the anomalous behavior was observed;
comparing an output of the fault-free simulation with an output of a fault-inserted simulation to identify fault symptoms exhibited by the fault-inserted simulation; and
comparing the identified fault symptoms with the fault symptoms input by the operator to evaluate a probability that the fault scenario caused the observed anomalous behavior.

7. The method as claimed in claim 4 further comprising permitting the operator to select one of the displayed fault scenarios to enter a free play simulation mode in which the fault scenario is inserted into the simulation.

8. A system for simulation-based troubleshooting of a complex system to isolate a cause of anomalous behavior observed during operation of the complex system, comprising:
a simulation of the complex system with a virtual complex system (VCS) control station that permits an operator to operate the VCS to an initial control conditions that simulates an operating state of the real complex system when the anomalous behavior was observed; and
a graphical user interface associated with the VCS control station that permits the operator to enter a fault symptom input mode, and to input fault symptoms observed during the anomalous behavior; and
a fault resolver that uses the input fault symptoms to select at least one candidate fault scenario that may have caused the anomalous behavior.

9. The system as claimed in claim 8 wherein the fault resolver inserts one of the fault scenarios into the simulation, and operates the simulation to determine whether symptoms exhibited by the fault-inserted simulation match the input fault symptoms, in order to assess a probability that the fault scenario was a cause of the anomalous behavior in the real complex system.

10. The system as claimed in claim 9 wherein the fault resolver displays a list of candidate fault scenarios to the operator to permit the operator to select a fault scenario to be inserted into the simulation and permit the operator to observe the behavior of the fault-inserted simulation in a free play mode.

11. The system as claimed in claim 10 wherein the operator graphical user interface permits the operator to switch from the simulation mode to the fault symptom input mode, input fault symptoms using the graphical user interface, and send a query containing the input fault symptoms and operating conditions to the fault resolver, which uses the input fault symptoms to select a list of candidate fault scenarios from a database of known fault scenarios associated with the complex system.

12. The system as claimed in claim 11 further comprising an interface that permits the fault resolver to query the operator for additional observed fault symptoms.

13. The system as claimed in claim 9 wherein the simulation and VCS control station are further adapted to resume the suspended simulation using respective ones of the inserted fault scenarios, until sufficient information is obtained to determine whether the input fault symptoms are observed in any fault-inserted simulation.

14. The system as claimed in claim 9 further comprising:
a fault-free simulation of the complex system that is run in parallel with the fault-inserted simulation;
a symptom extractor for identifying differences between a behavior of the fault-free simulation and the fault-inserted simulation; and
a symptom comparator for comparing the extracted symptoms with the symptoms input by the operator to evaluate and rank a probability that the fault scenario is a cause of the observed anomalous behavior, and to produce a ranked list of fault scenarios.

15. The system as claimed in claim 14 wherein the system simulates system behavior with the fault-inserted scenario at the operator's control station, while the symptoms are being extracted and compared.

16. The system as claimed in claim 14 wherein the system displays a ranked list of fault scenarios to the operator to permit the operator to select one of the fault scenarios, and to enter a free play mode in which the fault scenario is inserted.

17. A method of troubleshooting to determine a cause of an anomalous behavior observed during operation of a complex system, comprising:
providing a simulation of the complex system including an operator's control station that permits an operator to operate the simulation to, initial control conditions that existed when the anomalous behavior was observed;
accepting inputs from the operator at the operator's control station representing fault symptoms associated with the observed anomalous behavior; and
using the input fault symptoms to select at least one fault scenario that may have been responsible for the observed anomalous behavior.

18. The method as claimed in claim 17 further comprising:
inserting a selected fault scenario into a copy the simulation;
running the fault-inserted simulation in parallel with the fault-free simulation; and
comparing a state of the fault-inserted and the fault-free simulation to extract fault symptoms from the fault-inserted simulation.

19. The method as claimed in claim 18, further comprising:
comparing the extracted fault symptoms with the fault symptoms input by the operator; and
computing a probability that the fault scenario caused the anomalous behavior based on the comparison of the extracted fault symptoms with the input fault symptoms.

20. The method as claimed in claim 19, further comprising:
compiling a ranked fault scenario list containing an identification of the fault scenario and the computed probability; and
displaying the ranked fault scenario list to the operator.

21. The method as claimed in claim 20, further comprising:
associating at least one hyperlink with at least one fault scenario in the list prior to displaying the list to the operator, the at least one hyperlink permitting the operator to link to online documentation related to the fault scenario.
